(19) United States
(12) Patent Application Publication
(10) Pub. No.: US 2020/0293993 A1
(43) Pub. Date: Sep. 17, 2020

(54) PACKAGE DELIVERY BID SYSTEM AND METHOD

(71) Applicant: Go Plus Holdings Pte Ltd., Singapore (SG)

(72) Inventors: Erik Christian Anderson, Mill Valley, CA (US); Timothy Mathew Kobe, Singapore (SG); Pierre Habib, Singapore (SG); Massimiliano Terio, Singapore (SG)

(73) Assignee: Go Plus Holdings Pte Ltd., Singapore (SG)

(21) Appl. No.: 16/816,334

(22) Filed: Mar. 12, 2020

Related U.S. Application Data
(60) Provisional application No. 62/818,275, filed on Mar. 14, 2019.

(51) Int. Cl. G06Q 10/08; G06Q 10/10

(52) U.S. Cl. CPC G06Q 10/08345; G06Q 10/10

(57) ABSTRACT

A method and system of shipping a package including receiving a package from a user; inputting data regarding the package including the destination of the package; transmitting the data to a central server; submitting the data from the central server to a plurality of logistics vendors; and collecting delivery costs from at least one of the plurality of logistics vendors.

### CROSS REFERENCE TO RELATED APPLICATIONS

This application is related to and claims priority from earlier filed provisional patent application No. 62/818,275 filed on Mar. 14, 2019, entitled “PACKAGE DELIVERY SYSTEM DATA PUBLISHING,” hereby incorporated by reference in its entirety.

### BACKGROUND OF THE INVENTION

The present disclosure relates to a system and method of bidding out package shipment costs to lower the costs for the sender and the shipping companies.

In the package logistics industry, there are a large number of inherent inefficiencies that exist. These inefficiencies tend to increase costs for both the logistics companies and their customers. For example, if a logistics company has an established shipping route between two destination cities that is underutilized, the company may increase the cost of shipment between the two cities. The end customer likely does not know the capacity and utilization of a given logistics company's routes and is thus unable to adequately judge the relative value of the shipment costs. Moreover, the customer is unlikely to judge whether company A or company B would provide lower costs, as the time equity to research a one off shipment is relatively high. Similarly, the logistics company may be unaware that there are a number of customers looking to make shipments using shipping routes which are not at capacity—thus representing lost revenue.

Additionally, as the number of logistics companies has largely remained the same for many years—there is little incentive for the logistics companies to lower costs or compete for customers. Thus, the end costs for customers remains high, with little to no alternatives present for those customers and customers are left paying the price a given vendor demands—with little to no alternatives.

For the foregoing reasons, there is a need for a system and method which can aid in driving down costs for customers and vendors alike, thereby benefiting the customer by providing a bid system for new packages.

### SUMMARY OF THE INVENTION

The instant bid system seeks to remedy many of the above noted deficiencies in the prior art by collecting customer shipping needs (e.g. item weight, item size, destination, and/or speed of delivery) and allowing the various logistics companies to view and then bid on each package—against each other—to provide the customer with the lowest cost option.

For example, a customer may not have the benefit of knowing that a particular logistics company may have available space for their shipment on a vehicle that is going to be traveling to the local destination center regardless. The logistics company would benefit by accepting an additional package on the aforementioned vehicle, which may represent an already profitable trip between two nodes. As such, the logistics company may want to accept the additional package, maybe at a lower cost to the consumer, to increase the profitability of the overall shipment. Thus, both the consumer and the logistics company may benefit.

In some embodiments, a user may download an application, or app, for their portable personal electronic device, e.g. a smartphone, to log into the system. Once logged on, the user can then input the package size (e.g. in cubic volume), the package weight, the origin location, the destination, and the desired delivery date. After inputting the necessary information, the system can then direct user to a local drop off location to deposit the package, having been labeled with at least the destination address, for further processing. Concurrently, or at another time, the system can upload the data from the user to a central server, or repository, for review by partner logistics companies, or vendors. After a predetermined time, the vendors can then provide accurate bids for how much it would cost to ship the package using the respective logistics vendor. Once the user has been notified, by email, SMS text message, or notification from the app, of the available bids from the vendors, they can then determine which vendor to use. Alternatively, the system can determine the best value vendor for the customer automatically. After the vendor selection, the package can then be made available for pick up and shipment according to accepted practices.

Other benefits and objectives of the instant disclosure can be understood in view of the following detailed description, drawings, and claims.

### BRIEF DESCRIPTION OF THE DRAWING FIGURES

The novel features that are characteristic of the present disclosure are set forth in the appended claims. However, the disclosure's preferred embodiments, together with further objects and attendant advantages, will be best understood by reference to the following detailed description taken in connection with the accompanying drawings in which:

FIG. 1 shows the basic components of the present disclosure;

FIG. 2 shows a schematic of a logistics map; and

FIG. 3 shows a schematic view of one implementation of the present disclosure.

### DESCRIPTION OF THE INVENTION

In the package delivery industry, inefficiencies within logistics systems and market competition between the various players have trended to keep the costs to customers high. The instant system and method seeks to solve this problem through innovative usage of customer data and bidding by vendors. The instant system intends to use efficiencies and advertising revenue from the system to create a radical offer of low, to possibly no cost, shipping for customers.

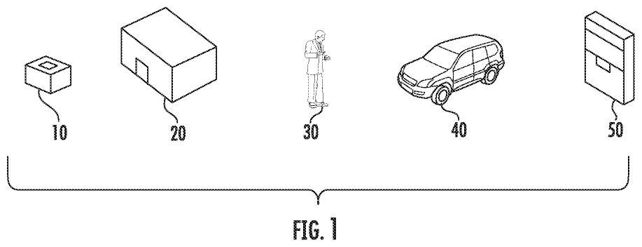

In general, with respect to FIG. 1, the instant system and method seeks to optimize package 10 delivery from retailers 20 or customers 30, to a destination address by a delivery vendor 40. The instant system provides for local drop-off stations 50 to allow the retailers 20, or customer 30, to have a centralized drop-off location for all packages 10 to the various delivery vendors 40. The system seeks to make use of an innovative mobile, internet, or local application and local stations to function as a distributed network of customer facing package pick up and drop off locations 50 to facilitate low cost shipping options for customers. The functionality of the system relies on existing delivery vendors 40 (e.g. USPS, UPS, FEDEX, etc.) to move the customer packages 10 from their points of origin to the intended destinations. However, the instant system provides a novel approach to increase efficiency within the existing delivery industry and pass those cost savings on to customers 30. By “publishing” the data (size, weight, destination) collected from the users (e.g. from the mobile application or local stations) for each package 10 in the system, many potential delivery vendors 40 will be able to integrate that data into their logistics systems and optimize the cost as a function of pick up locations, timing, volume, weight, and transit. Once the data is collected from the system it would be transmitted to all member vendors 40. Any delivery vendor could then “bid” on a package by quoting cost and speed. Because, now known, efficiencies reduce costs, the quotes from delivery vendors to customers are below market rate.

In one embodiment of this scheme, the lower cost can be derived from lower operating costs for the delivery vendors 40. As the individual vendors 40 reduce their operating costs, they can in turn pass, all or a portion, of the cost savings along to customers 30. In effect, because the vendors 40 are able to bid on those packages which would increase usage of existing routes, they can more efficiently transport goods through a logistics system. For example, if a delivery truck 42 is only half full, the vendor would still need to transport those goods over long distances. However, increasing the volume of goods in that vehicle would increase the profit from that specific delivery to a destination for a vendor. Thus, where a vendor may have been operating at a loss due to the low packing density of the vehicle, it can now increase the number of paid packages being transported. While there may be increased energy costs associated with a larger weight of goods being transported, it is understood that an increase in volume of customers will likely offset the increase in energy costs to operate the vehicle.

In another embodiment of this scheme, the system can additionally introduce advertising. For example, the individual kiosks, or drop-off locations, 50 can include a large screen which can be used as outward facing advertising when the kiosks are not being used by customers. As the screens are intended to be relatively large, they function as still, video, or even interactive advertisements on what would otherwise be a static street furniture (e.g. newspaper vending machines, bus stops, or benches). In some embodiments, the kiosks can offer the public local coupons which can be transmitted, electronically, to a user's personal electronic device. The revenue derived from the video advertising and coupons can then, in turn, be used to partially offset the customer costs of shipping, so that even lower costs are passed along to customers. In one embodiment, the revenue from advertising can fully offset the costs of shipping so that the cost to the customer is free. It is envisioned that the revenue from advertising, e.g. via an advertising contract with the logistics vendors or others, on the drop-off kiosks will be so high that it will offset the underlying shipping costs to the customers. This version is the most radical, but the most attractive since no cost shipping will act as a strong attraction and build the user base quickly.

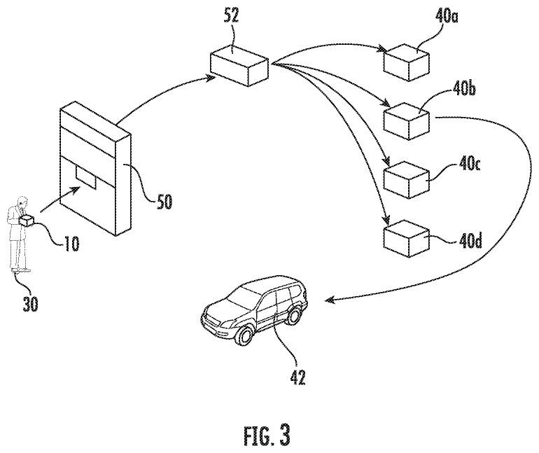

The instant system, as shown in FIG. 3, additionally, or alternatively, allows many delivery vendors 40a, 40b, 40c, 40d to compete for the packages 10 going through the system 52 to reduce the cost to the customer 30. Because the package delivery vendors 40a-d are independent, there are no efficiencies possible in terms of optimizing their logistics with all the potential packages that are in the system. As the system 52 collects important points of data from the customers 10, publishing that data (destination address, size and weight) of each package to multiple delivery vendors, the vendors 40a-d can run their logistics system to determine which packages optimize their business.

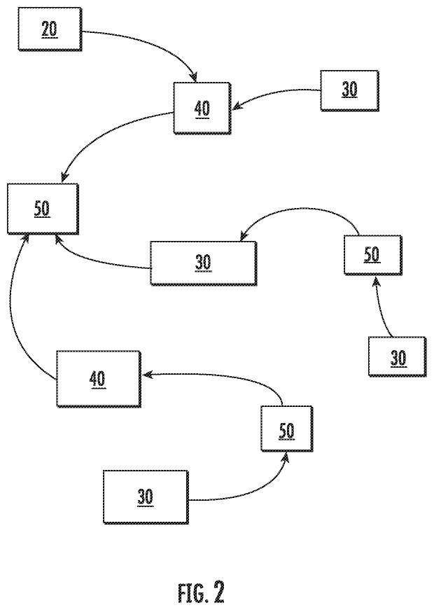

In one exemplary method of use, as shown in FIGS. 2 and 3, a single customer 30, or a plurality, may each desire to send a package. The customer 30 can take the package 10, labeled with a destination address, to a machine or storefront 50 that can accept the package from the customer, scans the delivery address, weighs it, documents the dimensions and generates a digital transaction record. The digital transaction record can then be transmitted to a central system server 52 via known electronic transmission systems (e.g. a wired or wireless network). Alternatively, the user can input that transaction record via a mobile application and transmit that data to the central system server ahead of dropping off the package. The central system server 52 can then publish the record to multiple delivery vendors 40a-d via electronic transmission. The various delivery vendors 40a-d can then integrate the data into their logistic systems and then offer a bid of a price and timing quote for each package that increases efficiency for both the delivery vendor and the customer. Once a bid is offered by a vendor and accepted by the customer, the system can release packages to the chosen delivery vendor 42 that meet relevant criteria. The delivery vendors can then dispatch vehicles to retrieve package and the package can continue through the logistic system according to known methods.

Further, as shown in FIG. 3, it is understood that a given vendor 40 can receive packages directly from retailers 20, customers 30, and drop-off locations 50. Similarly, the vendors can deliver packages to retailers 20, or customers 30, via current existing methods and similarly drop off packages at drop-off locations 50 for customer 30 pickup.

The present system relies on creating back end efficiencies between the central system 52 and the systems of multiple delivery vendors 40a-d, then passing on the gain of those efficiencies to customers 30. For example, the back end efficiencies can include optimization APIs which are run by individual logistics companies.

When a customer 30 desires to send a package 10, whether using a current delivery vendor or the instant system, a label that describes the intended destination address is applied to the package. However, using the instant system, the customer 10 can then locate the closest drop-off station 50 by using a downloaded app. The app can additionally allow the user to create an account so that customer information is saved to the central server for later use (e.g. for a new package at a later date). At the drop-off station 50, the customer can be identified by a wireless connection between the drop-off station and the mobile app, for example via BLUETOOTH or near field communications (NFC). In one example, the drop-off station 50 can be fully automatic and a station screen can welcome the customer 30 and prompts them to respond to several on screen queries. For example, the queries can include identification of the user via code or scanning a QR code, or a user can be identified via an account created on their personal electronic device. The automated drop-off station 50 can then open a delivery door and the customer 30 can then insert the package 10 into the machine. For example, the drop-off station 50 can be the same as the kiosk disclosed in co-pending U.S. application No. TBD, entitled “SCALABLE DISTRIBUTED DELIVERY STATIONS,” attorney docket no. G079 P03614-US1, filed on an even date, hereby incorporated by reference in its entirety. The automated drop-off station 50 can then scan the address or can retrieves it from data input into the app used to set up delivery. After, or before, the scan, the system can weigh and measures the dimensions of the package 10. Finally, the drop-off station 50 can then create a digital transaction record. Alternatively, the drop-off locations 50 can employ people to process packages in the same, or similar fashion.

The digital transaction record can then be transmitted to the central system 52 server which is a configuration of computers and communications hardware designed to quickly receive, process, and transmit data from the multitude of drop-off stations to a plurality of delivery vendors. Once the digital transaction is processed, the central system server can publish the data to a multitude of delivery vendors. Using known digital technologies for database sharing, the instant system can establish a protocol to create a new channel of communication between the drop-off stations and the vendors. The data for each package is shared using an industry wide protocol.

Each of the delivery vendors 40a-d, advantageously, integrates the digital transaction data into their logistics systems to look for efficiencies including, destination, volume and weight. For each package 10 that fits into its plan, the delivery vendor 40 can submit a quote including cost and timing to the central system 52. In one embodiment, the central system can evaluate the many quotes and selects a delivery vendor based on cost, timing, and reliability and then releases that digital transaction record to the selected delivery vendor for shipping. Alternatively, the various bids can be transmitted to the customer for selection.

The selected delivery vendor can then dispatch a vehicle to pick up the package from the drop-off station and then integrates the package into its delivery network. The delivery vendor then delivers the package to the final destination.

While the instant system is described as a part of the package delivery network, it is contemplated that there is application in other networks that rely on multiple players to function optimally.

It will be appreciated by those skilled in the art that various changes and modifications can be made to the illustrated embodiments without departing from the spirit of the present disclosure. All such modifications and changes are intended to be covered by the appended claims.

What is claimed is:

1. A method of shipping a package, the method comprising,
receiving a package from a user;
inputting data regarding the package including the destination of the package;
transmitting the data to a central server;
submitting the data from the central server to a plurality of logistics vendors; and
collecting delivery costs from at least one of the plurality of logistics vendors.

2. The method of claim 1, further comprising
collecting delivery costs, delivery time, and delivery reliability from a plurality of the plurality of logistics vendors; and
selecting one of the plurality of logistics vendors as a function of the collected delivery costs, delivery time, and delivery reliability.

3. The method of claim 1, wherein the data input regarding the package further includes the package weight and the package volume.

4. The method of claim 1, wherein the method is fully automatic.

5. The method of claim 1, further comprising,
receiving account information from the user generated on the user's personal electronic device.

6. The method of claim 1, further comprising,
handing off the package to one of the plurality of logistics vendors after the collecting step.
